(19) United States
(12) Patent Application Publication
(10) Pub. No.: US 2018/0252274 A1
(43) Pub. Date: Sep. 6, 2018

(54) ELECTRIC SLAVE CYLINDER FOR MANUALLY SHIFTED VEHICLES

(71) Applicant: GM Global Technology Operations LLC, Detroit, MI (US)

(72) Inventors: Daniel de Oliveira Rodrigues, Rochester Hills, MI (US); Leandro Peres Oliveira, Sao Paulo (BR)

(21) Appl. No.: 15/450,683

(22) Filed: Mar. 6, 2017

(51) Int. Cl. F16D 28/00; F16D 27/108

(52) U.S. Cl. CPC F16D 28/00; B60K 23/02; F16D 27/108

(57) ABSTRACT

An electric slave cylinder clutch actuation system includes a clutch pedal sensor connected to a clutch pedal. The clutch pedal sensor is actuated by rotation of the clutch pedal about a rotational axis of the clutch pedal to generate an electrical signal. An electric slave cylinder is positioned within a transmission housing of a vehicle transmission. The electric slave cylinder is in communication with the clutch pedal sensor and includes: a body adapted to receive an actuator housing; and a tube extending from the actuator housing positioned within the transmission housing having an electrical cable assembly extending through the tube to protect the electrical cable assembly within the transmission housing. An actuator positioned within the actuator housing is operated by the electrical signal transmitted via the electrical cable assembly to displace a clutch actuation plate into contact with a clutch plate.

### INTRODUCTION

The present disclosure relates to automobile vehicle manual clutch operating systems.

Known automobile vehicle manual clutch operating systems provide multiple component parts including a hydraulic fluid system connected to a clutch pedal communicating with a fluid reservoir. When the clutch pedal is actuated pressurized hydraulic fluid flows from a damper through a hydraulic fluid tube or line into the vehicle transmission to actuate a master slave cylinder. The master slave cylinder actuates or displaces the clutch between engaged and disengaged positions.

The clutch pedal must be actuated multiple times during vehicle operation to initially engage a first gear or a reverse gear, and to disengage the clutch when parking the vehicle. Multiple clutch pedal actuations are also required during stop and go driving when the transmission is in low or first gear, which lead to driver fatigue. Clutch wear is accelerated by these multiple clutch pedal actuations. Clutch wear is also accelerated by inconsistent operator use or misuse over time. Hydraulic system characteristics can also change the clutch “feel” over time.

Thus, while current manual clutch operating systems achieve their intended purpose, there is a need for a new and improved clutch operating system and method for operation.

### SUMMARY

According to several aspects, an electric slave cylinder clutch actuation system includes a clutch pedal sensor actuated by rotation of a clutch pedal to generate an electrical signal. An electric slave cylinder is in communication with the clutch pedal sensor. A clutch actuation plate displaced during operation of the electric slave cylinder upon receipt of the electrical signal to displace a clutch plate between an engaged positon and a disengaged position.

In an additional aspect of the present disclosure, the electric slave cylinder is positioned within a vehicle transmission.

In another aspect of the present disclosure, the electric slave cylinder is connected to internal structure of the vehicle transmission.

In another aspect of the present disclosure, the electric slave cylinder includes a body adapted to receive an actuator housing.

In another aspect of the present disclosure, a body extension is integrally connected to the body and having a mounting plate to which the actuator housing is connected using multiple fasteners.

In another aspect of the present disclosure, an electrical motor is positioned within the actuator housing.

In another aspect of the present disclosure, a gear rotated by operation of the electrical motor to displace the clutch actuation plate.

In another aspect of the present disclosure, a magnetic field generating unit positioned within the actuator housing.

In another aspect of the present disclosure, a member is displaced by a magnetic field created by operation of the magnetic field generating unit, the member contacting and displacing the clutch actuation plate.

In another aspect of the present disclosure, the electrical signal corresponds to a degree of rotation of the clutch pedal about a clutch pedal axis of rotation.

According to several aspects, an electric slave cylinder clutch actuation system includes a clutch pedal sensor actuated by rotation of a clutch pedal to generate an electrical signal. An electric slave cylinder is positioned within a transmission housing of a vehicle transmission. The electric slave cylinder is in communication with the clutch pedal sensor. The electric slave cylinder includes a body adapted to receive an actuator housing; and an actuator positioned within the actuator housing operated by the electrical signal to displace a clutch actuation plate.

In another aspect of the present disclosure, a clutch plate is contacted by the clutch actuation plate between an engaged positon and a disengaged position.

In another aspect of the present disclosure, the electric slave cylinder includes at least one mounting flange extending from the body fastened to internal structure of the vehicle transmission.

In another aspect of the present disclosure, the actuator defines an electrical motor positioned within the actuator housing which when energized by the electrical signal created by the clutch pedal sensor engages a drive member.

In another aspect of the present disclosure, a contact member is displaced by the drive member.

In another aspect of the present disclosure, the electric slave cylinder further includes an adapter.

In another aspect of the present disclosure, a transmission sealing member extends from the adapter, the transmission sealing member sealing a penetration location of the transmission housing.

In another aspect of the present disclosure, a tube extending from the adapter has an electrical cable assembly positioned partially within the tube for protection of the electrical cable assembly within the vehicle transmission.

In another aspect of the present disclosure, the actuator defines an electrical motor rotatably driving a drive member into contact with the clutch actuation plate.

According to several aspects, an electric slave cylinder clutch actuation system includes a clutch pedal sensor connected to a clutch pedal. The clutch pedal sensor is actuated by rotation of the clutch pedal about a rotational axis of the clutch pedal to generate an electrical signal. An electric slave cylinder is positioned within a transmission housing of a vehicle transmission. The electric slave cylinder is in communication with the clutch pedal sensor. The electric slave cylinder includes: a body adapted to receive an actuator housing; and a tube extending from the actuator housing positioned within the transmission housing having an electrical cable assembly extending through the tube to protect the electrical cable assembly within the transmission housing. An actuator is positioned within the actuator housing operated by the electrical signal transmitted via the electrical cable assembly to displace a clutch actuation plate into contact with a clutch plate.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a front right perspective view of a pedal arrangement including a clutch pedal and sensor according to an exemplary embodiment;

FIG. 2 is a front left perspective view of a transmission housing having an electric slave cylinder according to an exemplary embodiment;

FIG. 3 is a front perspective view of an electric slave cylinder according to an exemplary embodiment;

FIG. 4 is an end elevational view of the slave cylinder of FIG. 3;

FIG. 5 is a side elevational view of the slave cylinder of FIG. 3;

FIG. 6 is a cross sectional side elevational view taken at section 6 of FIG. 4;

FIG. 7 is a top left perspective view of a drive member according to an exemplary embodiment;

FIG. 8 is a front perspective view of a drive member according to an exemplary embodiment; and

FIG. 9 is a top right perspective view of a drive member according to an exemplary embodiment.

### DETAILED DESCRIPTION

The following description is merely exemplary in nature and is not intended to limit the present disclosure, application, or uses.

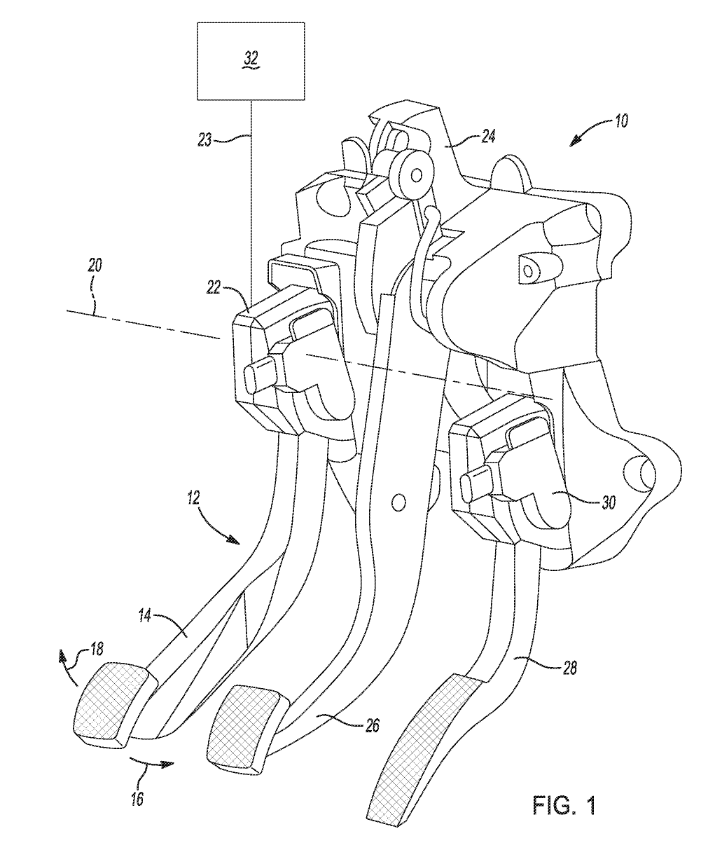

Referring to FIG. 1, an electric slave cylinder clutch actuation system 10 of the present disclosure includes in part a pedal system 12 having a clutch pedal 14 which is displaceable in each of a depression or clutch release direction 16 and an opposite return or clutch engagement direction 18. The clutch pedal 14 rotates with respect to an axis of rotation 20 using manual foot actuation by the vehicle operator in a known manner. The clutch pedal 14 can rotate about the axis of rotation 20 in an arc of rotation which according to several aspects can vary between approximately 20 degrees up to approximately 60 degrees to accommodate different vehicle designs and space constraints.

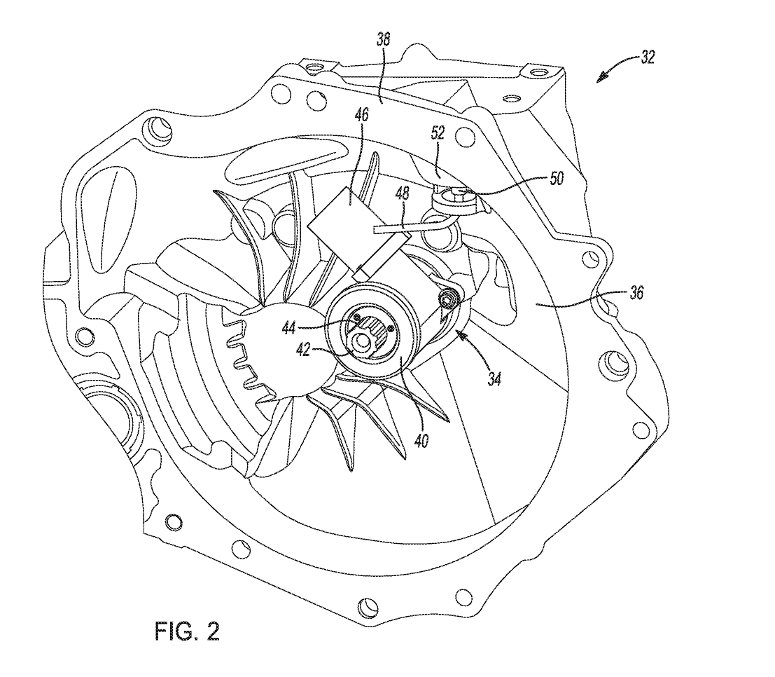

Clutch pedal 14 rotation about the axis of rotation 20 is sensed by a clutch pedal sensor 22. An electrical signal 23 is created by the clutch pedal sensor 22 during clutch pedal rotation which equates to or corresponds to a degree of rotation of the clutch pedal 14. For support, the clutch pedal 14 is rotatably mounted to a pedal structural support member 24, which can be mounted to vehicle structure such as a firewall. The pedal structural support member 24 can also rotatably support a brake pedal 26 and an accelerator pedal 28. For simplicity, the clutch pedal sensor 22 can be a duplicate of a known accelerator pedal sensor 30. The electrical signal 23 output from the clutch pedal sensor 22 is communicated to a vehicle transmission 32 shown and described in greater detail in reference to FIG. 2.

Referring to FIG. 2 and again to FIG. 1, the transmission 32 incorporating the electric slave cylinder clutch actuation system 10 also includes in part an electric slave cylinder actuator 34 which is positioned within a housing cavity 36 of a housing 38 of the vehicle transmission 32. According to several aspects, the electric slave cylinder actuator 34 is positioned within the same housing cavity 36 of the housing 38 of the vehicle transmission 32 as a clutch plate shown and described in reference to FIG. 6. Operation of the slave cylinder actuator 34 by the electrical signal 23 generated by the clutch pedal sensor 22 during rotation of the clutch pedal 14 displaces a clutch actuation plate 40. According to several aspects, the clutch actuation plate 40 is disposed on and axially displaced with respect to a transmission shaft 42. The transmission shaft 42 can include gear teeth such as a spline 44 which can extend beyond the clutch actuation plate 40.

The slave cylinder actuator 34 can include an actuator housing 46 to which is connected an electrical wiring containment sleeve or tube 48 which internally routes and protects power and control wiring leading from the clutch pedal sensor 22 to an actuator such as an electrical motor (shown and described in reference to FIG. 6) within the actuator housing 46. The tube 48 is provided with an adapter 50 for mounting the tube 48 to a structural member 52 of the transmission 32.

Referring to FIG. 3 and again to FIG. 2, the slave cylinder actuator 34 includes a cylindrical-shaped body 54 which is adapted to receive the actuator housing 46. According to several aspects, the actuator housing 46 is integrally connected to the body 54. A bore 56 created in a connecting member 58 provides rotation clearance for the transmission shaft 42. The connecting member 58 can also be used to connect the clutch actuation plate 40 to internal components of the slave cylinder actuator 34 (shown in greater detail in reference to FIG. 6) engaged or rotated by operation of a motor shown and described in reference to FIG. 6. At least two and according to several aspects three mounting flanges 60 extend from the body 54 which each provide an aperture 62 receiving a fastener (shown in FIG. 2) used for mounting the slave cylinder actuator 34 to the housing 38 of the transmission 32. A body extension 64 integrally connected to the body 54 provides a mounting plate 66 to which the actuator housing 46 is connected using multiple fasteners 68.

A sealing member 70 extending from the adapter 50 seals at a penetration location of the housing 38 of the transmission 32. An electrical cable assembly 72 is positioned partially within the tube 48 for protection of the electrical cable assembly 72 within the transmission 32. The electrical cable assembly 72 extends through the adapter 50 and the sealing member 70 and outward from the transmission 32. The electrical cable assembly 72 is then routed to an internal vehicle cabin and connected to the clutch pedal sensor 22.

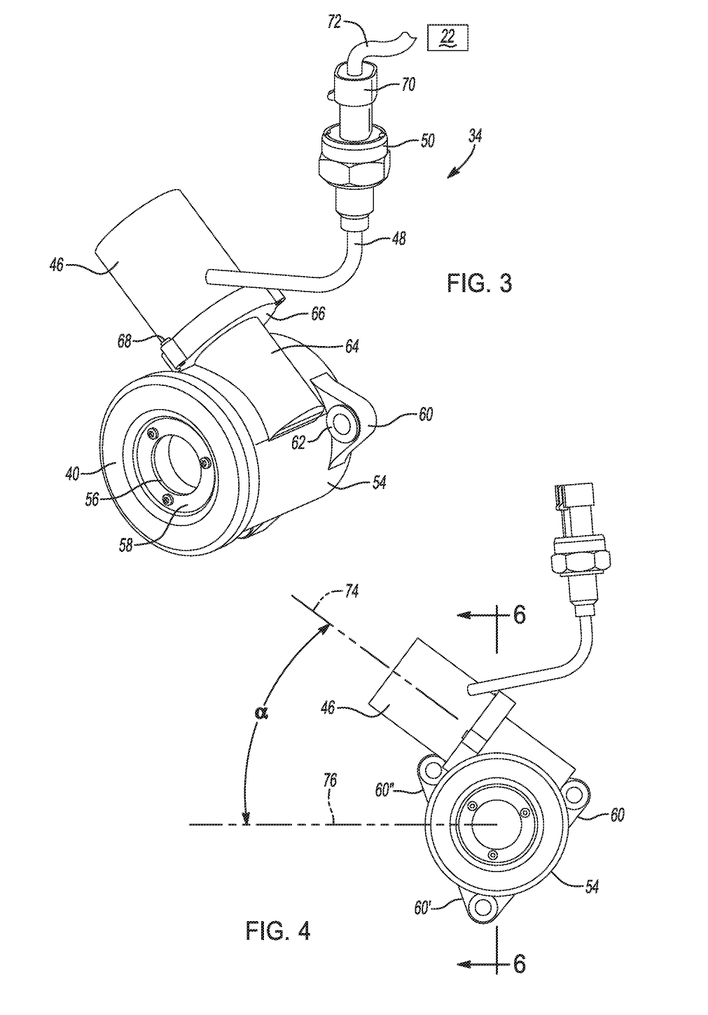

Referring to FIG. 4 and again to FIG. 3, according to an exemplary aspect three mounting flanges 60, 60′, 60″ are oriented at equal angular intervals about the body 54. A longitudinal central axis 74 of the actuator housing 46 is oriented at an angle alpha (α) with respect to a horizontal plane 76. Angle α is selected to suit clearance requirements of the slave cylinder actuator 34 within the transmission 32 and therefore sets the desired orientation of the mounting flanges 60, 60′, 60″.

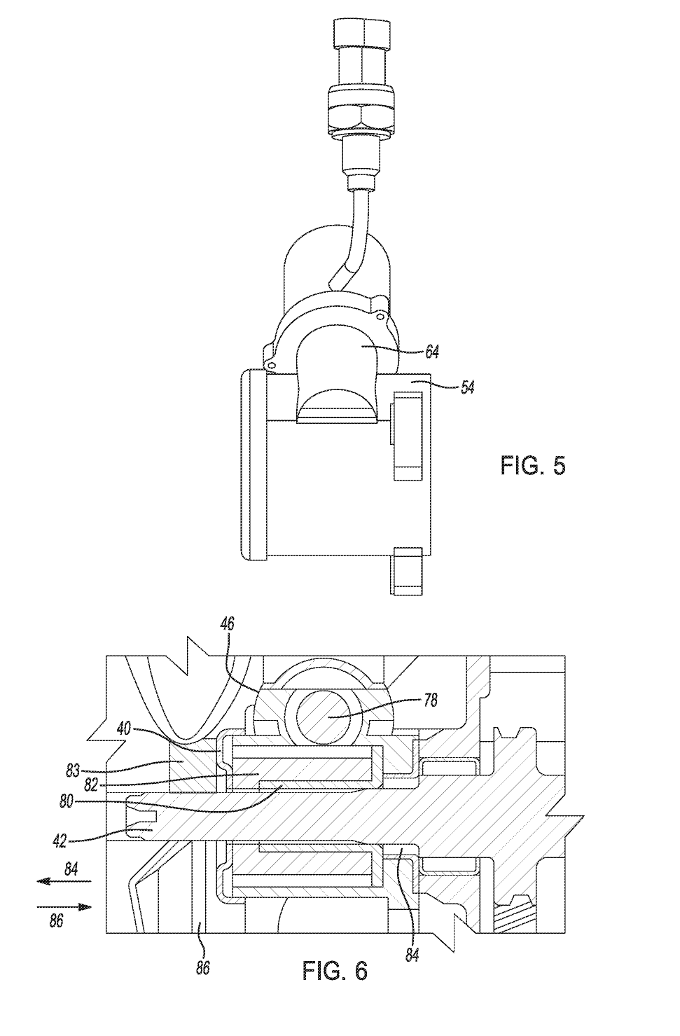

Referring to FIG. 5 and again to FIGS. 3 through 4, the body extension 64 provides a housing for mechanical or electrical drive components shown and described in reference to FIGS. 6 through 9 which act against and displace the clutch actuation plate 40. The configuration of the body extension 64 is therefore shown in one exemplary geometry, however, it is noted the geometry of the body extension 64 can vary depending on the components housed therein.

Referring to FIG. 6 and again to FIGS. 1 through 4, according to several aspects, the electric slave cylinder clutch actuation system 10 includes an actuator 78 such as a DC electrical motor positioned within the actuator housing 46 which when energized by the electrical signal 23 created by the clutch pedal sensor 22 engages a drive member 80. The drive member 80 displaces a contact member 82 which contacts and displaces the clutch actuation plate 40. According to several aspects the clutch actuation plate 40 contacts a clutch plate 83 (only partially shown for clarity) and displaces the clutch plate 83 in each of a clutch disengagement direction 84 and an oppositely directed clutch engagement direction 86. Use of the actuator 78 such as an electrical motor or coil allows precise displacement of the clutch actuation plate 40 for example by controlling a duration or an amplitude of the electrical signal 23, or by controlling a number of rotations, a displacement, or a magnetic flux of the actuator 78.

Referring to FIG. 7 and again to FIG. 6, according to further aspects, in lieu of the drive member 80 a drive system 88 can be used. The drive system 88 includes a threaded member 90 having threads engaged by one or more rings of ball bearings 92 used to displace the threaded member 90 and thereby to displace the clutch actuation plate 40.

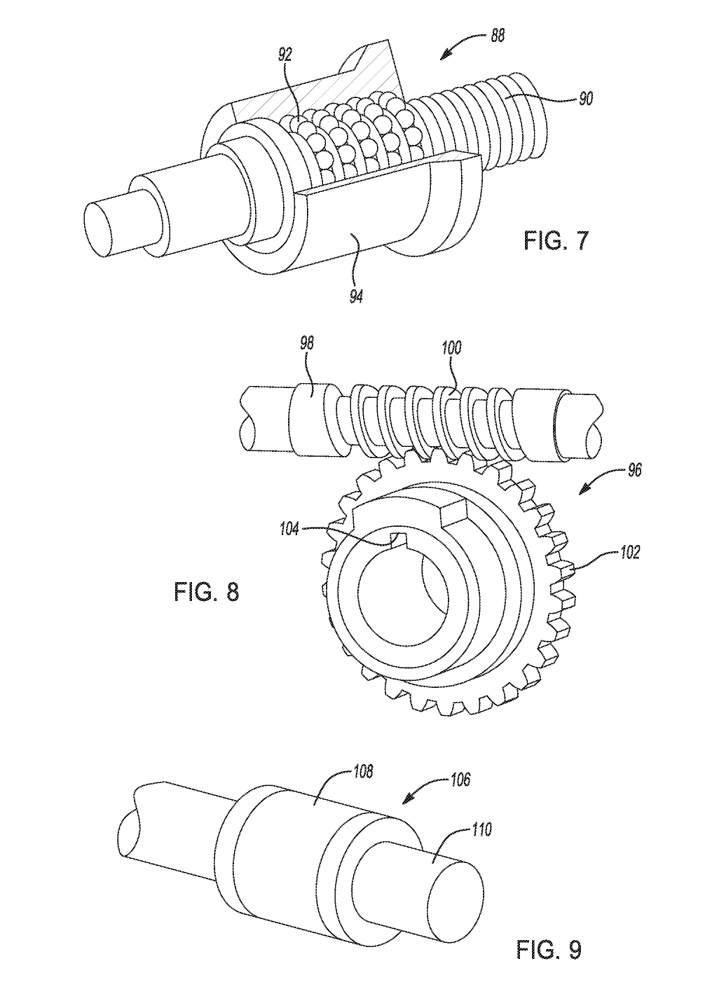

Referring to FIG. 8, according to further aspects, in lieu of the drive member 80 a drive system 96 can be used in conjunction with the actuator 78 which when energized can axially rotate a threaded shaft 98. The threaded shaft 98 includes a threaded portion 100 such as a helical gear which engages gear teeth 102 whose rotation axially extends a member 104 to displace the clutch actuation plate 40.

Referring to FIG. 9, according to further aspects, in lieu of the drive member 80, a magnetic drive system 106 can be energized by a magnetic field generated by a coil defining the actuator 78 in place of the electrical motor. The magnetic field can be with a coil member 108 to axially displace a shaft 110 which displaces the clutch actuation plate 40.

An electric slave cylinder clutch actuation system 10 of the present disclosure offers several advantages. These include the ability to replace the present hydraulic clutch controls which can induce clutch pressure variations over time with a “clutch-by-wire” system having electronically initiated, constant and repeatable clutch characteristics over the life of the clutch. The electric slave cylinder clutch actuation system 10 can be automatically operated electrically and eliminate the requirement to press the clutch pedal 14 for gear changes in both first gear and reverse, and therefore can be remotely operated to eliminate the need to press the clutch pedal 14 repeatedly during stop-and-go driving conditions. The electric slave cylinder clutch actuation system 10 also reduces the overall size, mass and complexity of the clutch actuation system compared to known hydraulic systems by elimination of tubing, fluid reservoirs, dampers, hydraulic connectors, and the like.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. An electric slave cylinder clutch actuation system, comprising:
a clutch pedal sensor actuated by rotation of a clutch pedal to generate an electrical signal;
an electric slave cylinder in communication with the clutch pedal sensor; and
a clutch actuation plate displaced during operation of the electric slave cylinder upon receipt of the electrical signal to displace a clutch plate between an engaged position and a disengaged position.

2. The electric slave cylinder clutch actuation system of claim 1, wherein the electric slave cylinder is positioned within a vehicle transmission.

3. The electric slave cylinder clutch actuation system of claim 2, wherein the electric slave cylinder is connected to internal structure of the vehicle transmission.

4. The electric slave cylinder clutch actuation system of claim 2, wherein the electric slave cylinder includes a body adapted to receive an actuator housing.

5. The electric slave cylinder clutch actuation system of claim 4, further including a body extension integrally connected to the body and having a mounting plate to which the actuator housing is connected using multiple fasteners.

6. The electric slave cylinder clutch actuation system of claim 4, further including an electrical motor positioned within the actuator housing.

7. The electric slave cylinder clutch actuation system of claim 6, further including a gear rotated by operation of the electrical motor to displace the clutch actuation plate.

8. The electric slave cylinder clutch actuation system of claim 4, further including a coil generating a magnetic field positioned within the actuator housing.

9. The electric slave cylinder clutch actuation system of claim 8, further including a member displaced by the magnetic field created by operation of the coil, the member contacting and displacing the clutch actuation plate.

10. The electric slave cylinder clutch actuation system of claim 1, wherein the electrical signal corresponds to a degree of rotation of the clutch pedal about a clutch pedal axis of rotation.

11. An electric slave cylinder clutch actuation system, comprising:
a clutch pedal sensor actuated by rotation of a clutch pedal to generate an electrical signal;
an electric slave cylinder positioned within a transmission housing of a vehicle transmission, the electric slave cylinder in communication with the clutch pedal sensor, the electric slave cylinder including a body adapted to receive an actuator housing; and
an actuator positioned within the actuator housing operated by the electrical signal to displace a clutch actuation plate.

12. The electric slave cylinder clutch actuation system of claim 11, further including a clutch plate contacted by the clutch actuation plate between an engaged position and a disengaged position.

13. The electric slave cylinder clutch actuation system of claim 11, wherein the electric slave cylinder includes at least one mounting flange extending from the body fastened to internal structure of the vehicle transmission.

14. The electric slave cylinder clutch actuation system of claim 11, wherein the actuator defines an electrical motor positioned within the actuator housing which when energized by the electrical signal created by the clutch pedal sensor engages a drive member.

15. The electric slave cylinder clutch actuation system of claim 14, further including a contact member displaced by the drive member.

16. The electric slave cylinder clutch actuation system of claim 11, wherein the electric slave cylinder further includes an adapter.

17. The electric slave cylinder clutch actuation system of claim 16, further including a transmission sealing member extending from the adapter, the transmission sealing member sealing a penetration location of the transmission housing.

18. The electric slave cylinder clutch actuation system of claim 16, further including a tube extending from the adapter having an electrical cable assembly positioned partially within the tube for protection of the electrical cable assembly within the vehicle transmission.

19. The electric slave cylinder clutch actuation system of claim 15, wherein the actuator defines an electrical motor rotatably driving a drive member into contact with the clutch actuation plate.

20. An electric slave cylinder clutch actuation system, comprising:
a clutch pedal sensor connected to a clutch pedal, the clutch pedal sensor actuated by rotation of the clutch pedal about an axis of rotation of the clutch pedal to generate an electrical signal;
an electric slave cylinder positioned within a transmission housing of a vehicle transmission, the electric slave cylinder in communication with the clutch pedal sensor, the electric slave cylinder including:
a body adapted to receive an actuator housing; and
a tube extending from the actuator housing positioned within the transmission housing having an electrical cable assembly extending through the tube to protect the electrical cable assembly within the transmission housing; and
an actuator positioned within the actuator housing operated by the electrical signal transmitted via the electrical cable assembly to displace a clutch actuation plate into contact with a clutch plate.
